(19) United States
(12) Patent Application Publication
(10) Pub. No.: US 2025/0206332 A1
(43) Pub. Date: Jun. 26, 2025

(54) Methods and Systems for using a Visual Language Model to Provide Remote Assistance to Vehicles

(71) Applicant: Waymo LLC, Mountain View, CA (US)

(72) Inventors: Ouais Alsharif, Mountain View, CA (US); Pan Li, Fremont, CA (US); Qichi Yang, Los Altos, CA (US); Bayram Safa Cicek, Mountain View, CA (US)

(21) Appl. No.: 18/392,299

(22) Filed: Dec. 21, 2023

(51) Int. Cl. B60W 60/00; B60W 30/09; G07C 5/00

(52) U.S. Cl. CPC B60W 60/001; B60W 30/09; G07C 5/008; B60W 2420/403; B60W 2540/00; B60W 2554/80

(57) ABSTRACT

Example embodiments relate to techniques for using visual language models (VLMs) to provide assistance to vehicles that encounter unexpected issues during navigation. A vehicle computing system may use sensor data to detect an unexpected issue impeding the vehicle from autonomously navigating a path and generate a question based on the unexpected issue. The computing system can then provide the question and a portion of the sensor data used to detect the unexpected issue to a remote computing device. The remote computing device inputs the question and the portion of the sensor data into a VLM trained to answer the question using the portion of the sensor data. The vehicle computing system is able to receive a response from the remote computing system and generate, based on the response, a control strategy for controlling the vehicle.

### BACKGROUND

Advancements in computing, sensors, and other technologies have enabled vehicles to safely navigate between locations autonomously, i.e., without requiring input from a human driver. By processing sensor measurements of the surrounding environment in near real-time, an autonomous vehicle can safely transport passengers or objects (e.g., cargo) between locations while avoiding obstacles, obeying traffic requirements, and performing other actions that are typically conducted by the driver. Shifting both decision-making and control of the vehicle over to vehicle systems can allow the vehicle's passengers to devote their attention to tasks other than driving. Some situations, however, can arise during navigation that may impact a vehicle's ability to navigate toward a destination.

As a vehicle navigates to a destination in an autonomous or semi-autonomous mode, the vehicle may encounter obstacles and other unexpected issues that can interfere and potentially block or otherwise disrupt its current trajectory. Construction sites, poorly marked roadways, stranded vehicles, misidentified objects, accidents, emergency vehicles, fallen objects, and/or obstructed views of signs or pathways are some potential situations encountered during navigation that can alter and sometimes temporarily limit the autonomous navigation of a vehicle.

In situations where the vehicle fails to independently overcome an obstacle encountered during navigation using onboard systems and sensor data (including failing to determine an alternative option with enough confidence to proceed), the vehicle may seek for additional assistance. For instance, the vehicle may prompt a passenger to provide assistance that can resolve the vehicle's issue. In some cases, the vehicle may submit a request for assistance that can be addressed by a remote operator who is positioned remotely from the vehicle and can review the situation in order to provide assistance.

Obtaining assistance from a passenger or a remote operator might have some challenges in some cases. The passenger may lack the ability to provide the vehicle with the necessary information to help the vehicle overcome its unexpected issue. In addition, the passenger might not be in a state that enables the passenger to immediately assist the vehicle. For instance, the passenger may be riding in the back seat of the vehicle and it might be unsafe for the passenger to move into a position within the vehicle that allows the passenger to assist the vehicle overcome the issue. Similarly, obtaining remote assistance from a human operator can take a substantial amount of time, which can delay the vehicle's navigation of the path. It takes time to establish a connection between the vehicle and the remote operator, who then needs to review the vehicle's situation in order to provide assistance. In addition, in some cases, the time required can be increased, such as when the human operators assigned to oversee a fleet of vehicles are helping other vehicles within the fleet and temporarily unavailable.

### SUMMARY

Example embodiments described herein relate to techniques for using a visual language model (VLM) to provide remote assistance to vehicles. During autonomous navigation, a vehicle may encounter various types of obstacles or other unexpected issues that disrupt the vehicle's ability to continue along its path. In some cases, the vehicle may seek assistance from a remote computing device by providing a question and sensor data representing the unexpected issue to the remote computing device. The remote computing device can use a VLM to analyze the vehicle's situation and generate an output for the vehicle that addresses the question. Such techniques can enable remote assistance to be provided to a fleet of vehicles in a timely manner without requiring oversight from a remote human operator except when a situation requires the operator's review.

In one aspect, an example method is provided. The method involves obtaining, at a computing system coupled to a vehicle, sensor data representing an environment of the vehicle. The sensor data is obtained from a sensor coupled to the vehicle while the vehicle is autonomously navigating a path in the environment. The method also involves detecting, based on the sensor data, an unexpected issue impeding the vehicle from autonomously navigating the path, generating a question based on the unexpected issue, and providing, by the computing system, the question and a portion of the sensor data used to detect the unexpected issue to a remote computing device. The remote computing device inputs the question and the portion of the sensor data into a visual language model (VLM) trained to answer the question using the portion of the sensor data. The method also involves receiving, at the computing system, a response from the remote computing system, and generating, based on the response, a control strategy for controlling the vehicle.

In another aspect, another method is provided. The method involves receiving, at a computing system, a question and sensor data from a vehicle. The question corresponds to an unexpected issue impeding the vehicle from autonomously navigating a path and the sensor data represents the unexpected issue. The method also involves providing the question and the sensor data as inputs into a visual language model (VLM) to generate an output that addresses the question. The method further involves transmitting, by the computing system and to the vehicle, a response based on the output that addresses the question.

In yet another example, an example non-transitory computer-readable medium having stored therein program instructions executable by a computing system comprising one or more processors to cause the computing system to perform operations is provided. The operations involve obtaining sensor data representing an environment of a vehicle. The sensor data is obtained from a sensor coupled to the vehicle while the vehicle is autonomously navigating a path in the environment. The operations also involve detecting, based on the sensor data, an unexpected issue impeding the vehicle from autonomously navigating the path, generating a question based on the unexpected issue, and providing, by the computing system, the question and a portion of the sensor data used to detect the unexpected issue to a remote computing device. The remote computing device inputs the question and the portion of the sensor data into a visual language model (VLM) trained to answer the question using the portion of the sensor data. The operations also involve receiving a response from the remote computing system and generating, based on the response, a control strategy for controlling the vehicle.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a vehicle, according to example embodiments.

FIG. 2A is an illustration of a physical configuration of a vehicle, according to example embodiments.

FIG. 2B is an illustration of a physical configuration of a vehicle, according to example embodiments.

FIG. 2C is an illustration of a physical configuration of a vehicle, according to example embodiments.

FIG. 2D is an illustration of a physical configuration of a vehicle, according to example embodiments.

FIG. 2E is an illustration of a physical configuration of a vehicle, according to example embodiments.

FIG. 2F is an illustration of a physical configuration of a vehicle, according to example embodiments.

FIG. 2G is an illustration of a physical configuration of a vehicle, according to example embodiments.

FIG. 2H is an illustration of a physical configuration of a vehicle, according to example embodiments.

FIG. 2I is an illustration of a physical configuration of a vehicle, according to example embodiments.

FIG. 2J is an illustration of a field of view for various sensors, according to example embodiments.

FIG. 2K is an illustration of beam steering for a sensor, according to example embodiments.

FIG. 3 is a conceptual illustration of wireless communication between various computing systems related to an autonomous or semi-autonomous vehicle, according to example embodiments.

FIG. 4 is a flow chart of a method for a vehicle obtaining remote assistance, according to one or more example embodiments.

FIG. 5 is another flow chart of a method for a remote computing system providing assistance to a vehicle, according to one or more example embodiments.

FIG. 6 illustrates a remote assistance situation, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Example embodiments described herein can decrease the amount of time required to assist vehicles by leveraging a VLM to address questions generated by the vehicles requesting assistance to overcome obstacles or other unexpected issues encountered during navigation. Rather than prompting a passenger or a remote human operator to provide assistance, disclosed techniques enable a vehicle experiencing an unexpected issue that is impeding navigation to receive assistance from a remote computing system programmed with one or multiple VLMs trained to provide assistance to vehicles. Upon detection of the unexpected issue, the vehicle can generate a question based on the unexpected issue and transmit the question along with sensor data as part of a request for assistance to the remote computing system. In response to receiving the request, the remote computing system can use a VLM to answer the question, which can then be provided to the vehicle for use to overcome the issue.

In general, a VLM is an artificial intelligence (AI) model designed to understand and generate natural language text in the visual content domain. Unlike text-based language models that primarily work with textual data, VLMs combine computer vision and natural language processing (NLP) techniques to process and generate text or other outputs based on visual information, such as images or other visual data. A computing system can use one or multiple VLMs to analyze and generate textual descriptions or explanations for visual content. In addition, a VLM can perform object recognition, understand scenes, and generate textual summaries of visual data. For instance, a computing system can use a VLM to perform visual question answering (VQA) for inquiries generated by vehicles navigating in various locations. The VLM can be used to answer questions about the content of images, allowing vehicles to ask questions about the surrounding environment and other obstacles that can impede navigation.

The VLM can be trained to address different types of requests for assistance generated by vehicles. For instance, the VLM can input and address a multiple choice question formulated by a vehicle where the request also includes at least a couple of options for the VLM to select from. The VLM can use the sensor data to select which option from multiple choices would enable the vehicle to continue navigation. As another example, the VLM can also receive and address trajectory questions where a vehicle provides sensor data along with a request for a modified path to circumnavigate an obstacle in the environment.

Vehicles can encounter a variety of issues that may prompt a vehicle to request for assistance. Some unexpected issues can arise in the external environment measured by vehicle sensors. For instance, a vehicle can encounter construction sites, unexpected objects, poorly painted road signs, vehicle accidents, emergency vehicles, or other situations that impede navigation of the vehicle. In some cases, vehicle systems may lack confidence with subsequent navigation options and request assistance as a result. A vehicle can also request assistance for other reasons, such as obtaining assistance for a situation related to its passengers.

Disclosed systems and techniques can scale easily to complete multiple tasks for various size fleets of vehicles and can develop and deploy tasks independent of other tasks. In addition, disclosed systems can also enable trainable tasks that are deployable on application-specific integrated circuits designed for neural networks (e.g., TPUs). In addition, disclosed techniques can allow for vehicles to obtain assistance with less latency. In some cases, the remote assistance process can allow the vehicle to receive and execute operations based on the assistance before the vehicle even comes to a stop in some instances.

Example systems within the scope of the present disclosure will now be described in greater detail. An example system may be implemented in or may take the form of an automobile, but other example systems can be implemented in or take the form of other vehicles, such as cars, trucks, motorcycles, buses, boats, airplanes, helicopters, lawn mowers, earth movers, boats, snowmobiles, aircraft, recreational vehicles, amusement park vehicles, farm equipment, construction equipment, trams, golf carts, trains, trolleys, and robot devices. Other vehicles are possible as well.

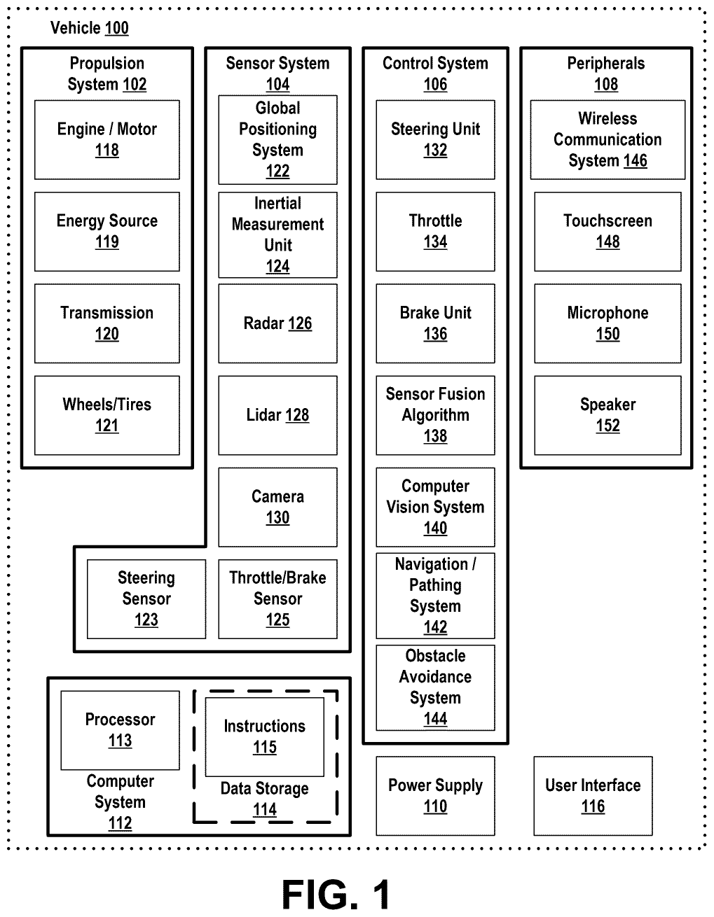

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), and emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., O₂ monitor, fuel gauge, engine oil temperature, and brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection) or in an incoherent detection mode (i.e., time-of-flight mode). In some embodiments, the one or more detectors of the lidar 128 may include one or more photodetectors, which may be especially sensitive detectors (e.g., avalanche photodiodes). In some examples, such photodetectors may be capable of detecting single photons (e.g., single-photon avalanche diodes (SPADs)). Further, such photodetectors can be arranged (e.g., through an electrical connection in series) into an array (e.g., as in a silicon photomultiplier (SiPM)). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, and a night vision camera) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve and a carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in the navigation of vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, or one or more machine-learned models) operable to process and analyze images in an effort to determine objects that are in motion (e.g., other vehicles, pedestrians, bicyclists, or animals) and objects that are not in motion (e.g., traffic lights, roadway boundaries, speedbumps, or potholes). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150 (e.g., one or more interior and/or exterior microphones), and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include processor 113 (which could include at least one microprocessor) operable to execute instructions 115 stored in a non-transitory, computer-readable medium, such as data storage 114. As such, processor 113 can represent one or multiple processors. In some embodiments, computer system 112 may represent a plurality of computing devices that may serve to control individual components or subsystems of vehicle 100 in a distributed fashion.

In some embodiments, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, or control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

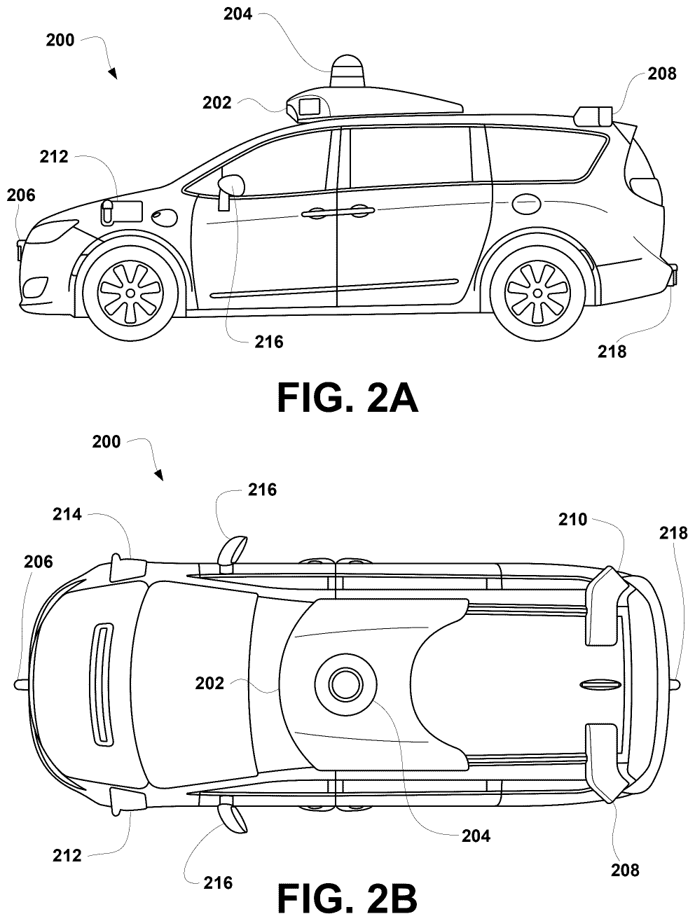

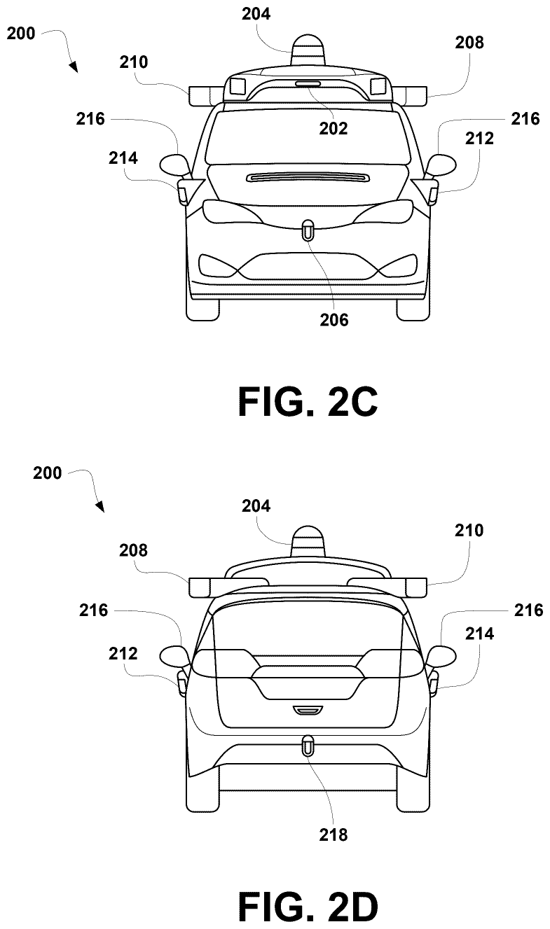

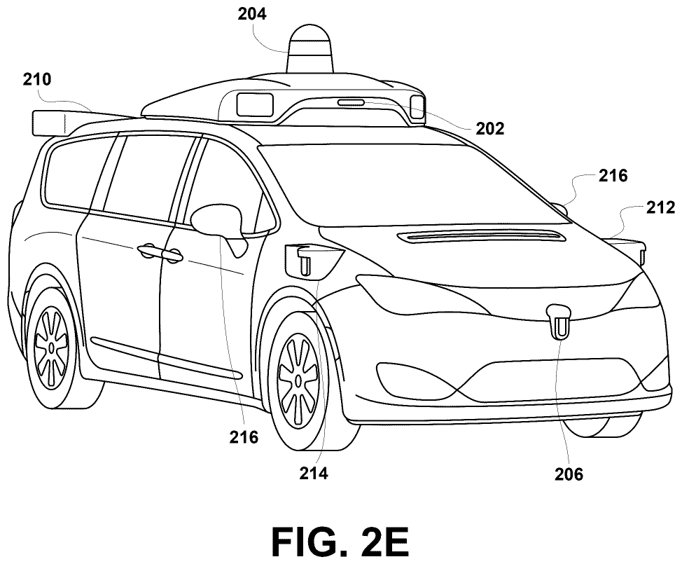

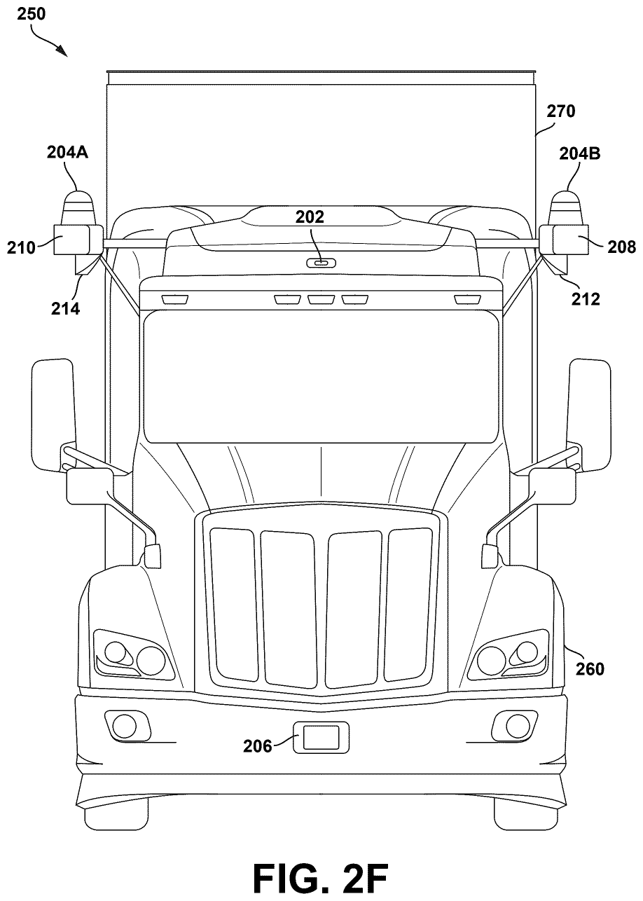

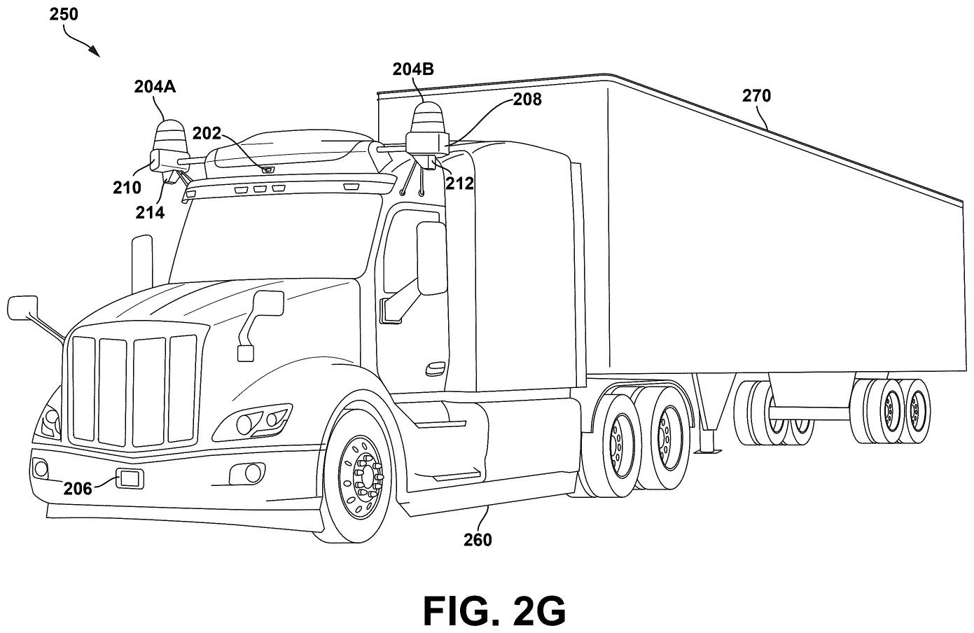

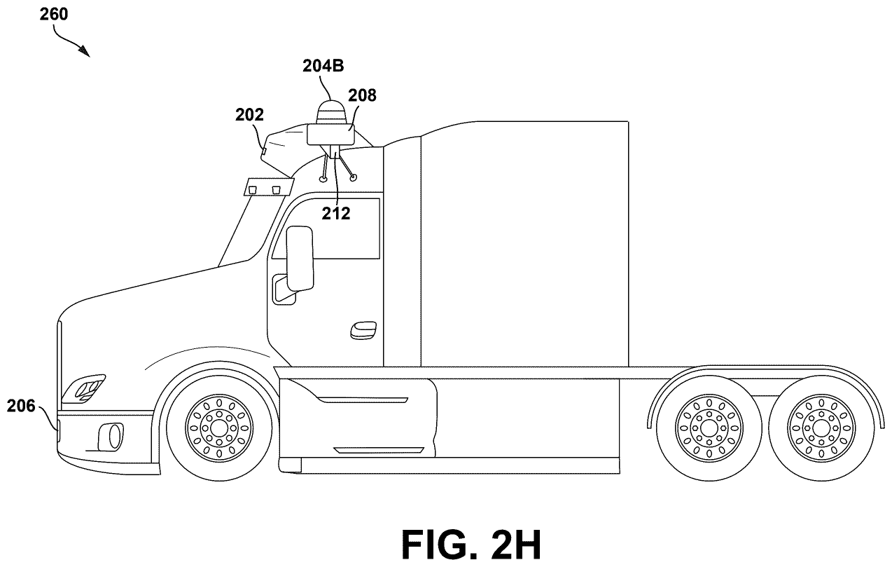

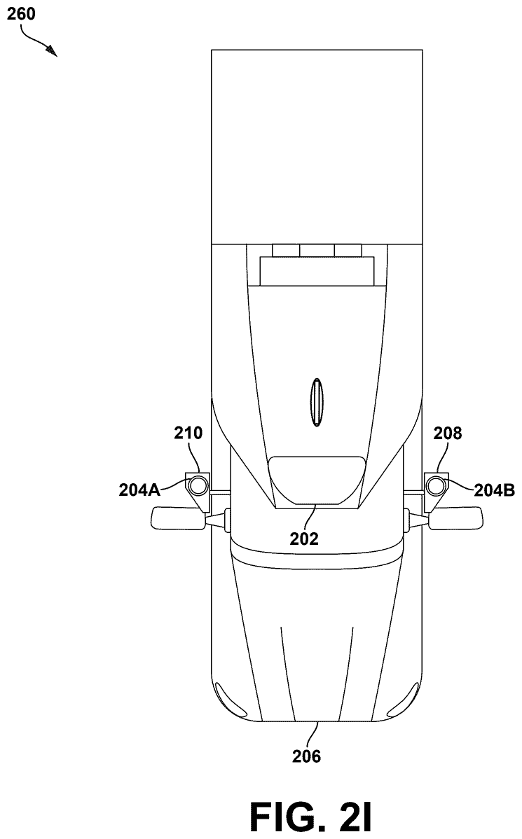

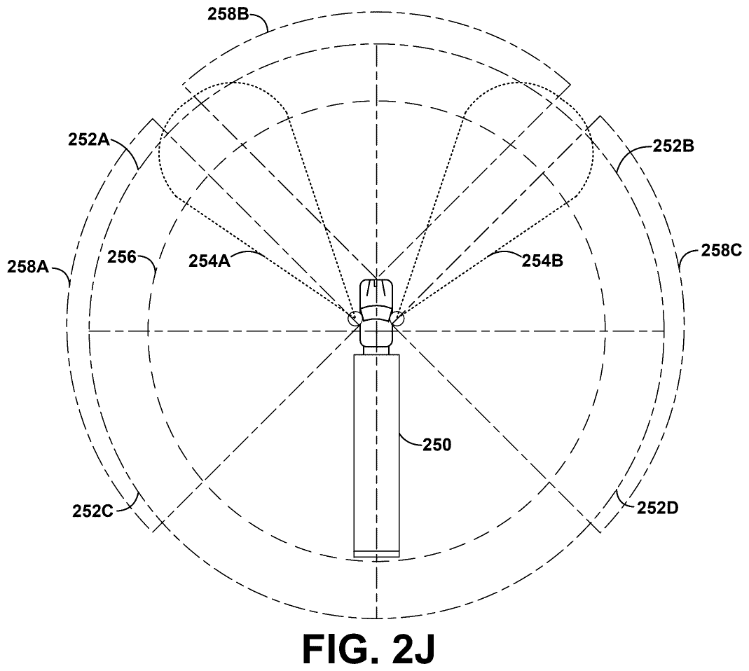

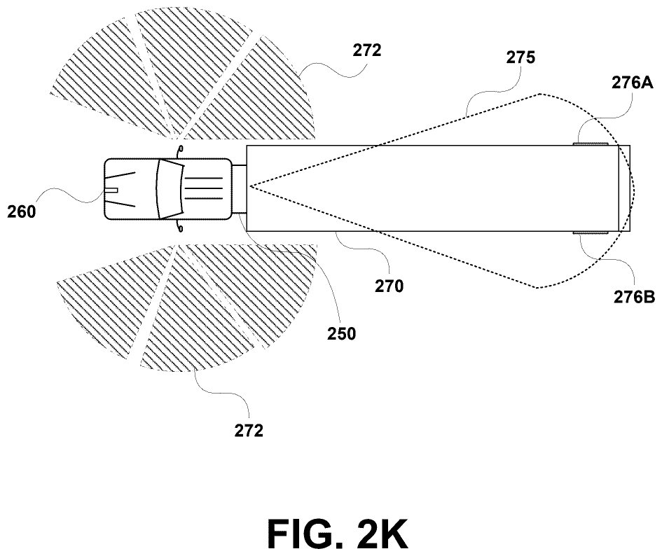

FIGS. 2A-2E show an example vehicle 200 (e.g., a fully autonomous vehicle or semi-autonomous vehicle) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices).

Vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras), one or more lidars, one or more radars, one or more inertial sensors, one or more humidity sensors, one or more acoustic sensors (e.g., microphones and sonar devices), or one or more other sensors configured to sense information about an environment that is surrounding vehicle 200. In other words, any sensor system now known or later created could be coupled to vehicle 200 and/or could be utilized in conjunction with various operations of vehicle 200. As an example, a lidar could be utilized in self-driving or other types of navigation, planning, perception, and/or mapping operations of vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; or one or more lidars, cameras, and radars).

Note that the number, location, and type of sensor systems (e.g., 202 and 204) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, or to adapt to specialized environmental or application circumstances). For example, the sensor systems (e.g., 202 and 204) could be disposed of in various other locations on the vehicle and could have fields of view that correspond to internal and/or surrounding environments of vehicle 200.

The sensor system 202 may be mounted atop vehicle 200 and may include one or more sensors configured to detect information about an environment that is surrounding vehicle 200, and output indications of the information. For example, sensor system 202 can include any combination of cameras, radars, lidars, inertial sensors, humidity sensors, and acoustic sensors (e.g., microphones and sonar devices). The sensor system 202 can include one or more movable mounts that could be operable to adjust the orientation of one or more sensors in the sensor system 202. In one embodiment, the movable mount could include a rotating platform that could scan sensors so as to obtain information from each direction around vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of sensor systems 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar devices. For example, the lidar devices could include a plurality of light-emitter devices arranged over a range of angles with respect to a given plane (e.g., the x-y plane). For example, one or more of sensor systems 202, 204, 206, 208, 210, 212, 214, and/or 218 may be configured to rotate or pivot about an axis (e.g., the z-axis) perpendicular to the given plane so as to illuminate an environment that is surrounding vehicle 200 with light pulses. Based on detecting various aspects of reflected light pulses (e.g., the elapsed time of flight, polarization, and intensity), information about the surrounding environment may be determined.

In an example embodiment, sensor systems 202, 204, 206, 208, 210, 212, 214, and/or 218 may be configured to provide respective point cloud information that may relate to physical objects within the surrounding environment of vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz). Such radio waves may be used to determine the distance to and/or velocity of one or more objects in the surrounding environment of vehicle 200. For example, one or more sensor systems 202, 204, 206, 208, 210, 212, 214, and/or 218 could include one or more radars. In some examples, one or more radars can be located near the rear of vehicle 200 (e.g., sensor systems 208 and 210), to actively scan the environment near the back of vehicle 200 for the presence of radio-reflective objects. Similarly, one or more radars can be located near the front of vehicle 200 (e.g., sensor systems 212 or 214) to actively scan the environment near the front of vehicle 200. A radar can be situated, for example, in a location suitable to illuminate a region including a forward-moving path of vehicle 200 without occlusion by other features of vehicle 200. For example, a radar can be embedded in and/or mounted in or near the front bumper, front headlights, cowl, and/or hood, etc. Furthermore, one or more additional radars can be located to actively scan the side and/or rear of vehicle 200 for the presence of radio-reflective objects, such as by including such devices in or near the rear bumper, side panels, rocker panels, and/or undercarriage, etc.

Vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, vehicle 200 can determine the distance to the points on the object. The predetermined light pattern may comprise infrared light, or radiation at other suitable wavelengths for such measurements. In some examples, the camera can be mounted inside the front windshield of vehicle 200. Specifically, the camera can be situated to capture images from a forward-looking view with respect to the orientation of vehicle 200. Other mounting locations and viewing angles of the camera can also be used, either inside or outside vehicle 200. Further, the camera can have associated optics operable to provide an adjustable field of view. Still further, the camera can be mounted to vehicle 200 with a movable mount to vary a pointing angle of the camera, such as via a pan/tilt mechanism.

Vehicle 200 may also include one or more acoustic sensors (e.g., one or more of sensor systems 202, 204, 206, 208, 210, 212, 214, 216, 218 may include one or more acoustic sensors) used to sense a surrounding environment of vehicle 200. Acoustic sensors may include microphones (e.g., piezoelectric microphones, condenser microphones, ribbon microphones, or microelectromechanical systems (MEMS) microphones) used to sense acoustic waves (i.e., pressure differentials) in a fluid (e.g., air) of the environment that is surrounding vehicle 200. Such acoustic sensors may be used to identify sounds in the surrounding environment (e.g., sirens, human speech, animal sounds, or alarms) upon which control strategy for vehicle 200 may be based. For example, if the acoustic sensor detects a siren (e.g., an ambulatory siren or a fire engine siren), vehicle 200 may slow down and/or navigate to the edge of a roadway.

Although not shown in FIGS. 2A-2E, vehicle 200 can include a wireless communication system (e.g., similar to the wireless communication system 146 of FIG. 1 and/or in addition to the wireless communication system 146 of FIG. 1). The wireless communication system may include wireless transmitters and receivers that could be configured to communicate with devices external or internal to vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

Vehicle 200 may include one or more other components in addition to or instead of those shown. The additional components may include electrical or mechanical functionality.

A control system of vehicle 200 may be configured to control vehicle 200 in accordance with a control strategy from among multiple possible control strategies. The control system may be configured to receive information from sensors coupled to vehicle 200 (on or off vehicle 200), modify the control strategy (and an associated driving behavior) based on the information, and control vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

As described above, in some embodiments, vehicle 200 may take the form of a van, but alternate forms are also possible and are contemplated herein. As such, FIGS. 2F-2I illustrate embodiments where vehicle 250 takes the form of a semi-truck. For example, FIG. 2F illustrates a front-view of vehicle 250 and FIG. 2G illustrates an isometric view of vehicle 250. In embodiments where vehicle 250 is a semi-truck, vehicle 250 may include tractor portion 260 and trailer 270 (illustrated in FIG. 2G). FIGS. 2H and 2I provide a side view and a top view, respectively, of the tractor portion 260. Similar to vehicle 200 illustrated above, vehicle 250 illustrated in FIGS. 2F-2I may also include a variety of sensor systems (e.g., similar to the sensor systems 202, 206, 208, 210, 212, 214 shown and described with reference to FIGS. 2A-2E). In some embodiments, whereas vehicle 200 of FIGS. 2A-2E may only include a single copy of some sensor systems (e.g., sensor system 204), vehicle 250 illustrated in FIGS. 2F-2I may include multiple copies of that sensor system (e.g., sensor systems 204A and 204B, as illustrated).

While drawings and description throughout may reference a given form of vehicle (e.g., semi-truck vehicle 250 or vehicle 200 shown as a van), it is understood that embodiments described herein can be equally applied in a variety of vehicle contexts (e.g., with modifications employed to account for a form factor of vehicle). For example, sensors and/or other components described or illustrated as being part of vehicle 200 could also be used (e.g., for navigation and/or obstacle detection and avoidance) in semi-truck vehicle 250.

FIG. 2J illustrates various sensor fields of view (e.g., associated with vehicle 250 described above). As described above, vehicle 250 may contain a plurality of sensors/sensor units. The locations of the various sensors may correspond to the locations of the sensors disclosed in FIGS. 2F-2I, for example. However, in some instances, the sensors may have other locations. Sensors location reference numbers are omitted from FIG. 2J for simplicity of the drawing. For each sensor unit of vehicle 250, FIG. 2J illustrates a representative field of view (e.g., fields of view labeled as 252A, 252B, 252C, 252D, 254A, 254B, 256, 258A, 258B, and 258C). The field of view of a sensor may include an angular region (e.g., an azimuthal angular region and/or an elevational angular region) over which the sensor may detect objects.

FIG. 2K illustrates beam steering for a sensor of a vehicle (e.g., vehicle 250 shown and described with reference to FIGS. 2F-2J), according to example embodiments. In various embodiments, a sensor unit of vehicle 250 may be a radar, a lidar, a sonar, etc. Further, in some embodiments, during the operation of the sensor, the sensor may be scanned within the field of view of the sensor. Various different scanning angles for an example sensor are shown as regions 272, which each indicate the angular region over which the sensor is operating. The sensor may periodically or iteratively change the region over which it is operating. In some embodiments, multiple sensors may be used by vehicle 250 to measure regions 272. In addition, other regions may be included in other examples. For instance, one or more sensors may measure aspects of the trailer 270 of vehicle 250 and/or a region directly in front of vehicle 250.

At some angles, region of operation 275 of the sensor may include rear wheels 276A, 276B of trailer 270. Thus, the sensor may measure rear wheel 276A and/or rear wheel 276B during operation. For example, rear wheels 276A, 276B may reflect lidar signals or radar signals transmitted by the sensor. The sensor may receive the reflected signals from rear wheels 276A, 276. Therefore, the data collected by the sensor may include data from the reflections off the wheel.

In some instances, such as when the sensor is a radar, the reflections from rear wheels 276A, 276B may appear as noise in the received radar signals. Consequently, the radar may operate with an enhanced signal to noise ratio in instances where rear wheels 276A, 276B direct radar signals away from the sensor.

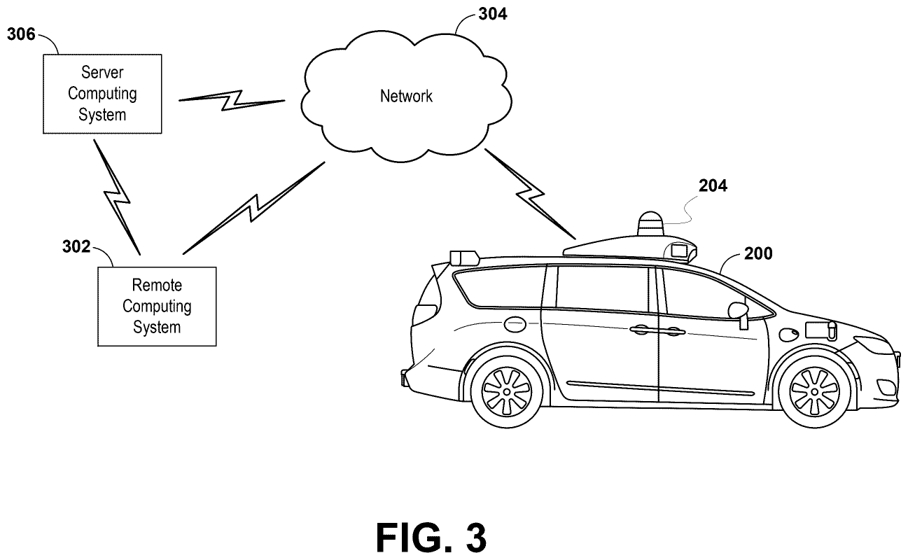

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, or a computing system local to vehicle 200) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environmental data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304), and in some embodiments, via a server (e.g., server computing system 306). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing the velocity of the vehicle (e.g., a speed and/or direction), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

Vehicles can encounter some situations that may cause issues for onboard control systems, but have a complexity level capable of being analyzed and addressed using powerful computing systems. When a vehicle encounters a situation having an unexpected issue that impedes operations of the vehicle, vehicle systems may transmit a request for assistance to a remote computing system that is serving as VQA system. The remote computing system can leverage one or multiple VLMs that can be used to analyze the situations causing issues for vehicles and generate responses that assist the vehicles.

During autonomous navigation, a vehicle may encounter various types of obstacles or other unexpected issues that disrupt the vehicle's ability to continue along its path. In some cases, the vehicle may seek assistance from the remote computing system by providing a question and sensor data that conveys aspects of the unexpected issue to the remote computing device. The remote computing device can use a VLM to analyze the vehicle's situation and generate an output for the vehicle that addresses the question. Such techniques can enable remote assistance to be provided to a fleet of vehicles in a timely manner without requiring oversight from a remote human operator except when a situation requires the operator's review.

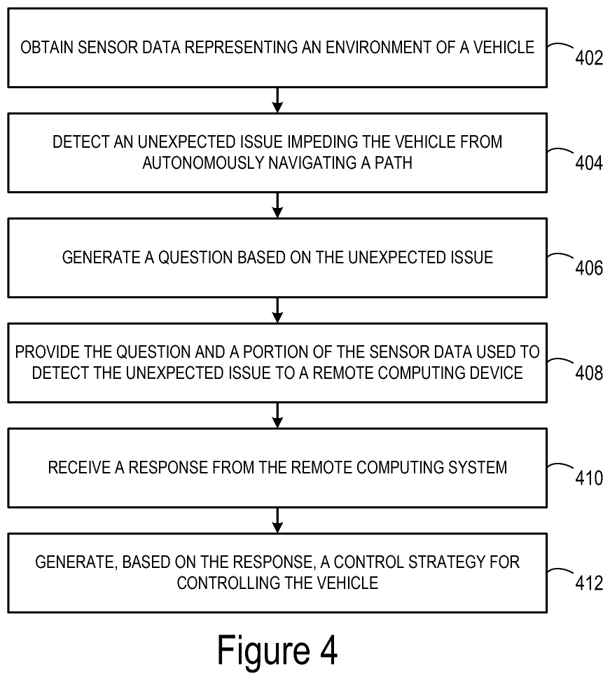

FIG. 4 is a flow chart of a method for a vehicle requesting remote assistance. Method 400 represents an example method that may include one or more operations, functions, or actions, as depicted by one or more of blocks 402, 404, 406, 408, 410, and 412, each of which may be carried out by any of the systems, devices, and/or vehicles shown in FIGS. 1-3, among other possible systems. For instance, system 300 depicted in FIG. 3 may enable execution of method 400.

Those skilled in the art will understand that the flowchart described herein illustrates functionality and operations of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 402, method 400 involves obtaining sensor data representing an environment of the vehicle. A computing system located onboard a vehicle can obtain the sensor data from a sensor coupled to the vehicle while the vehicle is autonomously navigating a path in the environment. The sensor or sensors providing sensor data to the computing system can vary within examples and may include one or more cameras, radar, and/or lidar, among others.

In addition, the computing system can also obtain sensor data that measures aspects of vehicle performance, such as a heading, location, speed, and acceleration of the vehicle. For instance, the computing system can receive sensor data from a GPS receiver, an IMU sensor, and other sensors that measure operations of components of the vehicle. In some examples, the computing system obtains sensor data representing an internal environment of the vehicle. For instance, the computing system can receive images representing an interior of the vehicle from one or more cameras positioned inside the vehicle.

At block 404, method 400 involves detecting, based on the sensor data, an unexpected issue impeding the vehicle from autonomously navigating the path. In general, the vehicle computing system can use sensor data to analyze the surrounding environment and generate a control strategy to safely navigate the environment. In some cases, the vehicle computing device may detect an unexpected issue that disrupts the planned strategy of the vehicle. The unexpected issue can vary within examples.

In some examples, the computing system receives images from a camera coupled to the vehicle and uses the images to detect an obstacle impeding the vehicle from autonomously navigating the path. In some cases, the computing system can modify its path to avoid the obstacle and continue on with navigation. In other cases, however, the computing system may not be able to confidently avoid the obstacle and come to a stop prior to requesting assistance from a remote computing device (while also monitoring the obstacle to see if the obstacle resolves itself).

In some examples, the unexpected issue impeding navigation can be related to the confidence associated with detecting or identifying an object in the vehicle's environment. For instance, the computing system may identify an object with a confidence level that is below a threshold confidence, which can trigger the computing system to stop (or remain stopped) and request for additional assistance with identifying the object.

At block 406, method 400 involves generating a question based on the unexpected issue. After detecting an unexpected issue that is impeding the vehicle's progress, the vehicle computing system may seek for additional assistance while also monitoring the unexpected issue for changes to the unexpected issue. In some cases, the unexpected issue may change and enable the vehicle to continue with its operations. When the unexpected issue remains, however, the vehicle computing system may use remote assistance as a way to overcome the issue and resume navigation.

As part of the request for remote assistance, the vehicle computing system may generate a question that conveys the unexpected issue impeding vehicle operations. Generation of the question can involve producing a natural question about a situation encountered during navigation. The vehicle computing system may integrate data from various sensors, cameras, and other sources and then process the data using natural language processing (NLP) techniques. In addition, the vehicle computing system may use contextual understanding and reasoning to formulate questions based on the perceived environment.

In addition, generation of the question can depend on one or multiple thresholds. For instance, the vehicle computing system may use confidence thresholds to determine when the vehicle fails to have enough confidence to proceed with a particular maneuver or navigation strategy. In such cases, the vehicle computing system may proceed to generate a question for an external computing system and/or human operator to address.

In some examples, the vehicle computing system may leverage communication protocols and interfaces that enable seamless interaction between the vehicle and a remote computing system. The vehicle computing system may initially identify the need for external assistance or information and then formulate a question in a standard format. The format can include natural language or can be a standardized format that can be understood by the remote computing system. For instance, the format may include a well-defined data structure or protocol for communication.

The question can take various forms within examples and can be provided along with potential answers for the remote computing system to select from. For instance, the question can be a trajectory-based question that requests for the remote computing system to articulate a trajectory for the vehicle to follow. A trajectory question can be generated along with one or multiple proposed paths that the vehicle computing system determined as potentially viable but under a confidence level that enables the vehicle to proceed without additional assistance.

In some examples, the vehicle computing system generates a multiple choice question, which can be supplemented with one or multiple answers determined by the vehicle computing system. In general, the multiple choice question can present the remote computing system with a question followed by a list of options that can be selected by the remote computing system. In some cases, the multiple choice question can have the form of a yes or no question that requires a binary response, where the answer can be either “yes” or “no”.

As an example, the vehicle computing system may detect a rapidly approaching vehicle from the rear in the adjacent lane and generate a question, such as “Should I change lanes to the left to allow the vehicle to pass, or maintain my current lane?” or a similarly phrased question. In another example, the vehicle computing system may encounter a situation where pedestrians are waiting to cross at a crosswalk. As such, the vehicle computing system may generate a question, such as “Are the pedestrians waiting to cross and it is safe to proceed, or should I come to a stop and yield to the pedestrians?” or a similarly phrased question. In a further example, the vehicle computing system may encounter a situation where it detects a large object in the middle of the road and may not confidently identify the object above a threshold confidence level. The vehicle computing system may then generate a question that asks “Is there an obstacle on the road that I should come to a stop or should I navigate around it?” or a similarly phrased question. Questions can be generated based on low visibility conditions, navigation decisions, and other situations encountered by vehicles.

At block 408, method 400 involves providing, by the computing system, the question and a portion of the sensor data used to detect the unexpected issue to a remote computing device. The vehicle computing system supplies the portion of sensor data in order to convey the situation to the remote computing device. For instance, the computing system can transmit images, point cloud data, and/or other types of sensor data that conveys the issue experienced by the vehicle to the remote computing system. Within examples, the quantity of sensor data and questions provided by the vehicle computing system can vary.

In some examples, the vehicle computing system uses standardized communication protocols to facilitate interaction with other computing devices (e.g., the remote computing system). The vehicle computing system may send formulated questions or requests along with other data using the established communication protocols, which may involve transmitting the information over a network or using direct communication channels.

The remote computing device inputs the question and the portion of the sensor data into a VLM trained to answer the question using the portion of the sensor data. A VLM combines natural language understanding with computer vision capabilities to process and generate content that involves both text and images. The VLM can be pre-trained on large datasets of text and images in order to learn to associate words and phrases with visual features in a way that encodes a rich understanding of environments experienced by vehicles. During pre-training, the VLM learns to recognize the relationships between textual descriptions and the visual elements in images, which helps the VLM build a comprehensive understanding of the content of both modalities. The pre-trained model is fine-tuned on specific downstream tasks related to assisting vehicles, such as question-answering, to adapt the VLM's knowledge to address situations encountered by vehicles.

When using images or another type of sensor data to answer questions, the VLM uses its pre-learned knowledge to interpret the content of the images (or sensor data) and the text-based question or questions provided by the vehicle. The VLM encodes both the textual and visual information into a shared semantic space, which allows the VLM to make a direct comparison. For question-answering, the VLM receives the question in natural language from the vehicle and sensor data as inputs. The VLM may then process the question and the sensor data separately and compute a similar score between them in the shared space. The answer can then be derived from the part of the image that is most semantically related to the question as determined by the similarity score. The VLM is able to provide answers based on its understanding of the vehicle's scenario factoring both the text and the sensor data, which makes the VLM versatile for cross-model comprehension when assisting vehicles.

At block 410, method 400 involves receiving, at the computing system, a response from the remote computing system. The remote computing system generates the response based on the output from the VLM, which can be transmitted to the vehicle for subsequent use. The response can take various forms within examples. For instance, the response can indicate a selection of an answer from one of the answers provided by the vehicle.

At block 412, method 400 involves generating, based on the response, a control strategy for controlling the vehicle. For instance, the vehicle computing system may generate a control strategy based on the answer selected by the remote computing system.

In some examples, the computing system can generate a multiple choice question and at least two answer options based on the unexpected issue. The computing system can then provide the multiple choice question and at least two answer options to the remote computing device. For instance, the computing system can determine that a confidence corresponding to an identification of an object located along the path is below a threshold confidence. The computing system can then generate a multiple choice question that requests for the identification of the object. The computing system may also generate answer options to provide to the remote computing system. For instance, the computing system can generate a first answer option based on a first identification determined for the object by the computing system and a second answer option based on a second identification determined for the object by the computing system. In some cases, the computing system can then receive a selection of the first answer option from the remote computing device and generate the control strategy based on the first identification determined for the object by the computing system.

In some examples, the computing system generates a trajectory question that requests for one or more modifications to its current path of travel. For instance, the computing system may detect an obstacle blocking its current path and provide the trajectory question to the remote computing system as part of a request for assistance. The computing system can determine a first modified path and a second modified path based on detecting the obstacle blocking the path. Navigating according to the first modified path or the second modified path enables the vehicle to circumvent the obstacle. As such, the computing system may provide a first answer option representing the first modified path and a second answer option representing the second modified path along with the trajectory question to the remote computing device. For instance, the computing system may determine that a confidence associated with navigating according to the first modified path or the second modified path is below a threshold confidence. The computing system may then provide the data representing the first modified path and the second modified path along with the trajectory question to the remote computing device in response to determining that the confidence associated with navigating according to the first modified path or the second modified path is below the threshold confidence. The computing system may then receive a selection of the first answer option from the remote computing system and generate the control strategy based on the first modified path.

In some examples, the computing system obtains images representing an interior environment of the vehicle from a camera coupled to the vehicle and detects an item located inside the vehicle after a passenger exited the vehicle. The computing system may then generate a particular question that requests whether the vehicle includes any items left behind by the passenger. The computing system may then receive a given response that confirms the vehicle includes the item left behind by the passenger and generate the control strategy based on the given response.

In some examples, the computing system may cause the vehicle to pull over or remain stationary based on detecting the unexpected issue. The computing system can then monitor the unexpected issue using subsequent sensor data and cause the vehicle to proceed along the path based on receiving the response from the remote computing system or detecting a change to the unexpected issue. The vehicle computing system may integrate information received from the remote computing system into its decision-making process, which may involve updating navigation instructions, adjusting driving behavior, or making other relevant changes based on the external input.

In addition, the communication between the vehicle computing system and external devices can include one or multiple authentication mechanisms that are used to verify the legitimacy of the communication between the computing systems.

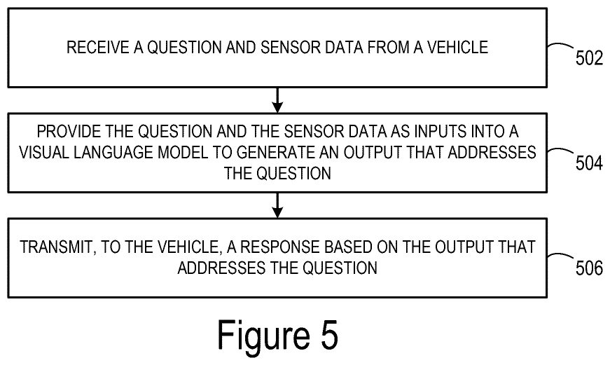

FIG. 5 is another flow chart of a method for a remote computing system providing assistance to a vehicle, according to example implementations. Method 500 represents an example method that may include one or more operations, functions, or actions, as depicted by one or more of blocks 502, 504, and 506, each of which may be carried out by any of the systems, devices, and/or vehicles shown in FIGS. 1-3, among other possible systems.

Those skilled in the art will understand that the flowchart described herein illustrates functionality and operations of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 502, method 500 involves receiving, at a computing system, a question and sensor data from a vehicle. The question corresponds to an unexpected issue impeding the vehicle from autonomously navigating a path and the sensor data represents the unexpected issue. The computing system is positioned remotely from the vehicle and can communicate with the vehicle via wireless communication. In some examples, the computing system may communicate and provide assistance to a fleet of vehicles that are geographically distributed.

At block 504, method 500 involves providing the question and the sensor data as inputs into a VLM to generate an output that addresses the question. The computing system may use one or multiple VLMs to serve as a question-answering system for providing assistance to vehicles. In some examples, the computing system may receive requests for assistance from multiple vehicles and simultaneously address the questions in parallel.

At block 506, method 500 involves transmitting, by the computing system and to the vehicle, a response based on the output that addresses the question. The response can include a selected answer or instructions generated based on analyzing the vehicle's situation.

The computing system can analyze and assist vehicles in various scenarios through a combination of technologies and processes, which can involve client-server architectures and communication protocols. The computing system can consist of one or multiple computing devices that can receive queries from vehicles via a network connection. For instance, the computing system can be a server that contains software, data, and algorithms to answer questions generated by vehicles. The communication between the computing system and vehicles can be encrypted.

In some examples, the computing system receives a multiple choice question and at least two answer options from the vehicle, which can then be provided as inputs into the VLM along with sensor data received from the vehicle. The VLM can be used to generate an output that selects one of the answer options (e.g., a first answer option from the at least two answer options).

In other examples, the computing system receives a trajectory question and sensor data representing a position of an obstacle from the vehicle. The obstacle corresponds to the unexpected issue that triggered the vehicle to request for assistance. The computing system can then provide the trajectory question and the sensor data representing the position of the obstacle as inputs into the VLM and generate a given output that indicates a modified path for the vehicle to navigate to circumvent the obstacle.

In some examples, the remote computing system may detect an issue with answering a question provided by a vehicle. For instance, the remote computing system may fail to differentiate between two answers provided by the vehicle. In such situations, the remote computing system may prompt a human operator to review the situation and provide assistance to the vehicle. Triggers for the remote computing system to prompt a human operator to provide additional assistance vary within examples. For instance, if the remote computing system is unable to provide an answer to the question transmitted by a vehicle or unable to select an answer with confidence above a threshold confidence, the remote computing system may provide an alert to a human operator. The human operator can then review the vehicle's question and situation in order to provide a response for the vehicle to use.

In some examples, the remote computing system may generate an answer in response to a request for assistance and provide the answer for review by a human operator. After obtaining an approval from the human operator, the remote computing system may then transmit the answer (or instructions) to the vehicle.

In some examples, the remote computing system can aggregate data from providing assistance to vehicles and use the data to enhance its model or models in a continuous feedback loop. For instance, the process can involve the remote computing system collecting interactions and data generated when providing assistance to vehicles and using the sensor to further train VLM. The remote computing system can collect the questions, sensor data, outcomes, and any updates provided by the vehicles to further improve the performance of the VLM. In some examples, the remote computing system can further communicate with vehicles after providing assistance to the vehicles to determine if the assistance provided to the vehicles solved the issues for the vehicles. For instance, a vehicle can indicate whether the response provided by the VLM enabled the vehicle to circumvent an issue or if additional assistance was needed. In some cases, the vehicle may provide a score based on the assistance provided by the remote computing system after navigating according to the assistance generated by the remote computing system.

By aggregating and analyzing a diverse dataset accumulated by assisting vehicles, the remote computing system can identify patterns and obtain further examples that can be used for training the VLM. The aggregated data can be used to train and refine the underlying learning model (e.g., the VLM), which enables the model to become more accurate and context-aware in assisting vehicles. The feedback loop allows the remote computing system to adapt to evolving needs of vehicles and changing environments. Continuous data aggregation and model refinement can ensure that the assistance provided by the remote computing system remains up-to-date and useful for assisting vehicles.

In some examples, the remote computing system may receive information from multiple vehicles and prioritize based on the type of question submitted by each vehicle. Similarly, the remote computing system may also perform parallel processing to address questions simultaneously. The remote computing system may also anticipate questions and prepare potential responses based on the locations of vehicle submitting the questions. For example, the remote computing system may anticipate questions based on multiple vehicles being located in the same general location at different times. The remote computing system can address questions related to construction sites or other situations efficiently by anticipating potential questions.

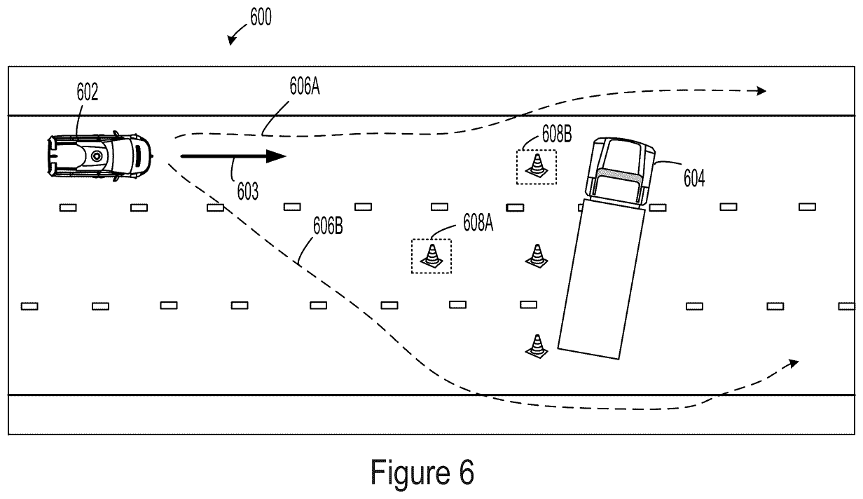

FIG. 6 illustrates remote assistance situation 600 where vehicle 602 can perform disclosed techniques to obtain assistance from a remote computing system. As vehicle 602 navigates along path 603 toward a destination, obstacles or other unexpected issues can arise. In the example embodiment shown in FIG. 6, truck 604 is blocking all lanes of the road upon which vehicle 602 is navigating upon. As shown, truck 604 is oriented across all the lanes of the road and has cones positioned in front of truck 604 to provide a visual warning to vehicles driving along the road.

In some cases, onboard vehicle computing systems can analyze and resolve the unexpected issues. For instance, vehicle 602 may use onboard planning to modify its path to avoid obstacles or other issues. When alternative options are readily available, vehicle 602 may be able to adjust its navigation strategy in real-time and avoid the unexpected issues (e.g., an obstacle blocking its path). As an example, if truck 604 was only blocking a subset of the available lanes, the onboard computing systems may be able to adjust its strategy for vehicle 602 and cause vehicle 602 to navigate in the unblocked lane around truck 604. Similarly, vehicle 602 can also continue to monitor an unexpected issue using sensors and determine that the unexpected issue is no longer an issue, enabling vehicle 602 to resume navigation along path 603. For instance, if truck 604 was able to move from its position, making the lanes on the road available again, vehicle 602 may be able to continue navigation without requiring remote assistance.

In other cases, however, vehicle 602 may require additional assistance to overcome a challenge triggered by some unexpected issue. The example embodiment shown in FIG. 6 represents a situation where additional assistance may be needed in order to enable vehicle 602 to resume navigation along path 603. For instance, in view of truck 604 blocking all the lanes of the road, vehicle 602 may determine that onboard systems lack enough confidence with future actions to continue on path 603 and seek additional support from another source, such as a remote computing system. As such, vehicle 602 can perform disclosed techniques to request and obtain assistance from the remote computing system. In some examples, vehicle 602 is programmed to pull over or remain stationary while performing disclosed techniques to reduce potential safety hazards associated with the unexpected issue. While stopped, vehicle 602 can continue to monitor the unexpected issue using sensor data (e.g., the position of truck 604) and potentially have the opportunity to resume navigation prior to receiving assistance in cases when the unexpected issue resolves itself.

To obtain assistance, vehicle 602 may generate a question that reflects the unexpected issue. In particular, the generation of the question enables a remote computing system or a human operator at the remote computing system to understand the obstacle that vehicle 602 is trying to resolve or overcome. Since various issues can arise during vehicle navigation, the question can vary within different scenarios. For instance, some scenarios may prompt vehicle 602 to generate a question related to object detection or identification. As an example, vehicle 602 may generate a natural language question that asks “Is there an object located here?” or “What is the identification of this object?” among other object oriented questions.

In the example embodiment shown in FIG. 6, vehicle 602 can generate a question or a series of questions specific to truck 604 blocking all lanes of the road, preventing vehicle 602 from navigating path 603. For instance, vehicle 602 can generate a trajectory question that asks “Should vehicle 602 continue navigation along modified trajectory option 606A or modified trajectory option 606B to navigate around truck 604?” This question offers two answer options for the remote computing system to select from when providing assistance to vehicle 602. In addition, vehicle 602 may generate the question based on an inability to temporarily leave the road without explicit approval from a remote source in some examples.

The question serves as an example and can include additional modified trajectories options in addition to modified trajectories options 606A-606B for the remote computing system to choose from. In other examples, the question can simply ask “What path should vehicle 602 use to navigate around truck 604?” or a similarly formatted question. As such, vehicle 602 can transmit these questions (and potential answer options) along with sensor data (e.g., images) to the remote computing system for review. The sensor data can also include location data that enables the remote computing system to understand the specific location of vehicle 602. In some cases, the location data can enable the remote computing system to match the unexpected issue of vehicle 602 to other situations experienced by vehicles who also encountered truck 604 in its current orientation and used the remote computing system for assistance.

In addition, in the example scenario, vehicle 602 can also provide other types of questions to the remote computing system as part of a request for assistance. For instance, vehicle 602 can generate a question or questions, such as “Is this object a traffic cone?” or “Are these objects traffic cones?” Vehicle 602 may generate these questions or similar questions and provide sensor data representing one or both of traffic cones 608A, 608B as well as other sensor data representing other aspects of the situation. Vehicle 602 may generate these object-specific questions when object detection or identification is below a threshold confidence level, which can prevent vehicle 602 from fully understanding the surrounding environment. As such, in some scenarios, vehicle 602 may encounter a scene that has multiple objects or elements that contribute to an unexpected issue. For instance, an unexpected issue can arise for vehicle 602 when encountering a construction site, a narrow path, or an accident, etc. Such situations may trigger vehicle 602 to generate a trajectory-based question, which can request for the remote computing system to specify a path for vehicle 602 to follow to avoid the issue.

The remote computing system that receives the question or questions from vehicle 602 can address the question(s) in various ways. In some cases, the remote computing system may input the question and corresponding sensor data into a VLM trained to use the sensor data to answer questions generated by vehicles. Vehicle 602 can receive a response from the remote computing system and subsequently generate a control strategy based on the response. For instance, vehicle 602 may receive a response that provides identifications for traffic cones 608A, 608B. Similarly, vehicle 602 may receive a response that selects either modified trajectory option 606A or modified trajectory option 606B, which enables vehicle 602 to then resume navigation around truck 604.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprises:
obtaining, at a computing system coupled to a vehicle, sensor data representing an environment of the vehicle, wherein the sensor data is obtained from a sensor coupled to the vehicle while the vehicle is autonomously navigating a path in the environment;
detecting, based on the sensor data, an unexpected issue impeding the vehicle from autonomously navigating the path;
generating a question based on the unexpected issue;
providing, by the computing system, the question and a portion of the sensor data used to detect the unexpected issue to a remote computing device, wherein the remote computing device inputs the question and the portion of the sensor data into a visual language model (VLM) trained to answer the question using the portion of the sensor data;
receiving, at the computing system, a response from the remote computing system; and
generating, based on the response, a control strategy for controlling the vehicle.

2. The method of claim 1, wherein generating the question based on the unexpected issue comprises:
generating a multiple choice question and at least two answer options based on the unexpected issue; and
wherein providing the question and the portion of the sensor data used to detect the unexpected issue to the remote computing device comprises:
providing the multiple choice question and the at least two answer options to the remote computing device.

3. The method of claim 2, wherein detecting the unexpected issue that impedes the vehicle from autonomously navigating the path comprises:
determining that a confidence corresponding to an identification of an object located along the path is below a threshold confidence; and
wherein generating the multiple choice question and the at least two answer options comprises:
generating the multiple choice question that requests for the identification of the object; and
generating a first answer option based on a first identification determined for the object by the computing system and a second answer option based on a second identification determined for the object by the computing system.

4. The method of claim 3, wherein receiving the response from the remote computing system comprises:
receiving a selection of the first answer option from the remote computing device; and
wherein generating the control strategy for controlling the vehicle comprises:
generating the control strategy based on the first identification determined for the object by the computing system.

5. The method of claim 1, wherein generating the question based on the unexpected issue comprises:
generating a trajectory question that requests for one or more modifications to the path; and
wherein providing the question and sensor data representing the unexpected issue to the remote computing device comprises:
providing the trajectory question to the remote computing device.

6. The method of claim 5, wherein detecting the unexpected issue that impedes the vehicle from autonomously navigating the path comprises:
detecting an obstacle blocking the path.

7. The method of claim 6, further comprising:
based on detecting the obstacle blocking the path, determining a first modified path and a second modified path, wherein navigating according to the first modified path or the second modified path enables the vehicle to circumvent the obstacle; and
wherein providing the trajectory question to the remote computing device comprises:
providing a first answer option representing the first modified path and a second answer option representing the second modified path along with the trajectory question to the remote computing device.

8. The method of claim 7, further comprising:
determining that a confidence associated with navigating according the first modified path or the second modified path is below a threshold confidence; and
wherein providing data representing the first modified path and the second modified path along with the trajectory question to the remote computing device comprises:
providing the data representing the first modified path and the second modified path along with the trajectory question to the remote computing device in response to determining that the confidence associated with navigating according to the first modified path or the second modified path is below the threshold confidence.

9. The method of claim 7, wherein receiving the response from the remote computing system comprises:
receiving a selection of the first answer option from the remote computing system; and
wherein generating the control strategy for controlling the vehicle comprises:
generating the control strategy based on the first modified path.

10. The method of claim 1, wherein obtaining sensor data representing the environment of the vehicle from the sensor coupled to the vehicle comprises:
receiving images from a camera coupled to the vehicle; and
wherein detecting, based on the sensor data, the unexpected issue impeding the vehicle from autonomously navigating the path comprises:
detecting, based on the images, an obstacle impeding the vehicle from autonomously navigating the path.

11. The method of claim 1, wherein obtaining sensor data representing the environment of the vehicle from the sensor coupled to the vehicle comprises:
obtaining images representing an interior environment of the vehicle from a camera coupled to the vehicle.

12. The method of claim 11, wherein detecting the unexpected issue impeding the vehicle from autonomously navigating the path comprises:
detecting an item located inside the vehicle after a passenger exited the vehicle; and
wherein generating the question based on the unexpected issue comprises:
generating a particular question that requests whether the vehicle includes any items left behind by the passenger.

13. The method of claim 12, wherein receiving the response from the remote computing system comprises:
receiving a given response that confirms the vehicle includes the item left behind by the passenger; and
wherein generating the control strategy for controlling the vehicle comprises:
generating the control strategy based on the given response.

14. The method of claim 1, further comprising:
based on detecting the unexpected issue, causing the vehicle to pull over or remain stationary;
monitoring the unexpected issue using subsequent sensor data; and
causing the vehicle to proceed along the path based on receiving the response from the remote computing system or detecting a change to the unexpected issue.

15. A method comprising:
receiving, at a computing system, a question and sensor data from a vehicle, wherein the question corresponds to an unexpected issue impeding the vehicle from autonomously navigating a path and the sensor data represents the unexpected issue;
providing the question and the sensor data as inputs into a visual language model (VLM) to generate an output that addresses the question; and
transmitting, by the computing system and to the vehicle, a response based on the output that addresses the question.

16. The method of claim 15, wherein receiving the question and sensor data from the vehicle comprises:
receiving a multiple choice question and at least two answer options from the vehicle.

17. The method of claim 16, wherein providing the question and the sensor data as inputs into the VLM to generate the output that addresses the question comprises:
providing the multiple choice question, the at least two answer options, and the sensor data as inputs into the VLM; and
generating the output that selects a first answer option from the at least two answer options.

18. The method of claim 15, wherein receiving the question and sensor data from the vehicle comprises:
receiving, from the vehicle, a trajectory question and sensor data representing a position of an obstacle, wherein the obstacle corresponds to the unexpected issue.

19. The method of claim 18, wherein providing the question and the sensor data as inputs into the VLM to generate the output that addresses the question comprises:
providing the trajectory question and the sensor data representing the position of the obstacle as inputs into the VLM; and
generating a given output that indicates a modified path for the vehicle to navigate to circumvent the obstacle.

20. A non-transitory computer-readable medium configured to store instructions, that when executed by a computing system comprising one or more processors, causes the computing system to perform operations comprising:
obtaining sensor data representing an environment of a vehicle, wherein the sensor data is obtained from a sensor coupled to the vehicle while the vehicle is autonomously navigating a path in the environment;
detecting, based on the sensor data, an unexpected issue impeding the vehicle from autonomously navigating the path;
generating a question based on the unexpected issue;
providing, by the computing system, the question and a portion of the sensor data used to detect the unexpected issue to a remote computing device, wherein the remote computing device inputs the question and the portion of the sensor data into a visual language model (VLM) trained to answer the question using the portion of the sensor data;
receiving a response from the remote computing system; and
generating, based on the response, a control strategy for controlling the vehicle.
